(19) United States
(12) Patent Application Publication
(10) Pub. No.: US 2010/0232417 A1
(43) Pub. Date: Sep. 16, 2010

(54) MOVING SERVICE CONTROL WITHIN A MOBILE TELEPHONY SERVICE PROVIDER NETWORK FROM A CHANNEL ACCESS DOMAIN TO AN IP DOMAIN

(75) Inventor: MARC SEGRE, RALEIGH, NC (US)

Correspondence Address: PATENTS ON DEMAND, P.A. - IBM CHA, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/404,045

(22) Filed: Mar. 13, 2009

(51) Int. Cl. H04L 12/66

(52) U.S. Cl. 370/352

(57) ABSTRACT

A telecommunication call attempt involving a mobile phone number can be identified at a mobile telephony service provider network. Call control for the call can be moved from a circuit switched, channel access domain to an IP domain by moving control form a mobile switching controller (MSC) component to a media gateway controller (MGC) component. Signaling and routing can them be handled by an IMS core. A SIP registry (e.g., HSS or HLR) can associated enterprise applications with mobile phone numbers. Based upon SIP registry entries, the IMS core can communicate with an enterprise, and receive results from SIP applications executing in the enterprise. The results can change signaling and/or routing behavior of the call attempt.

### BACKGROUND

The present invention relates to the field of mobile communications and, more particularly, to moving service control within a mobile telephony service provider network from a channel access domain to an IP domain.

Convergence has long been a goal in telecommunications, where fixed resources (e.g., a communication infrastructure) are highly leveraged to provide multiple differentiated services, which were previously distinct from each other. Convergence ideally benefits both end-users and service providers as it lowers overall costs for services while expanding markets that a service provider can penetrate. Two terms often associated with convergence include a triple play (providing fixed telephony, mobile telephony and fixed-line internet services) and a quadruple play, which adds television services to a triple play. It is not uncommon for telecommunication, internet, and other companies to form cooperative agreements in order to provide triple and quadruple play services to end customers.

One problem with conventional converged telecommunication services relates to the level of integration among different services. At present, most service providers loosely integrate different types of services. For example, fixed telephony services are associated with one phone number, mobile telephony services are associated with a different telephone number, fixed internet are associated with a discrete URL, etc. These services fail to interact cooperatively from an end user viewpoint, meaning that in absence of explicit call forwarding that has been manually established by a user, an incoming call to a disabled mobile phone is not transferred to the fixed line phone and vice versa. Further, settings and knowledge relating to a user via one of the services (e.g., a presence detection service, a calendar system, and the like) are not leveraged by other services to facilitate seamless communication across different service boundaries. Customers increasingly desire their communication assets join into a ubiquitous whole, where a user can choose a communication technology most suitable for a given situation (e.g., telephony calling, PTT communication, IMing, Text Messaging, co-browsing, media or file sharing, etc.), and can use this communication technology to communicate with a set of selected people.

Before different services can be integrated seamlessly at low levels, tighter integration of communication environment assets than presently exists is needed. This is especially true regarding integration of fixed network assets (internet, fixed telephony) and mobile network assets (mobile telephony towers, base stations, and the like). More specifically, today's mobile voice services provided by mobile telephony infrastructure assets are provided as 2G services (TDMA, CDMA, GSM) that do not directly integrate with IP technologies, such as SIP or VOIP, at lower levels. Thus, advanced features of an advanced intelligent network (AIN) are unavailable. The current limitations largely relate to a manner in which service call control is handled. Basically, it is presently difficult to move a mobile telephony session from a 2G channel accessed telephony domain (TDMA, CDMA, GSM, etc.) to an IP domain.

Current solutions to communications to an IP domain all have substantial drawbacks. In some instances, for example, tighter integration has been achieved through use of proprietary techniques and protocol extensions. These, however, are of limited utility as the proprietary extensions, which are not supported by other providers, become unavailable when a communication extends beyond the infrastructure assets of a single provider. Further, in the rapidly changing space of telecommunications, proprietary techniques are often hard to maintain and to integrate with emerging protocols, infrastructure improvements, and communication standards.

Other solutions require customers to purchase and use IP-PBX equipment. Use of IP-PBX equipment can be expensive, can result in customer experienced lock-in, can degrade service quality (when excessive analog to digital conversions occur). Further, IP-PBX equipment use is inherently limiting in mobile communication situations, as users of mobile devices connect to a provider's network from different geographic locations (as opposed to always connecting first to IP-PBX equipment, which converts communications to the IP domain, and then connects to the provider's network.)

### BRIEF DESCRIPTION OF THE SEVERAL VIEWS OF THE DRAWINGS

FIG. 1 is a flow chart of a method in which mobile telephony communications are moved from a channel access domain to an IP domain in accordance with an embodiment of the inventive arrangements disclosed herein.

FIG. 2 is a schematic diagram of a communications system that facilitates communications between a provider environment and an enterprise environment by moving communications from a channel access domain to an IP domain in accordance with an embodiment of the inventive arrangements disclosed herein.

FIG. 3 shows one specific embodiment of a provider environment.

FIG. 4 shows one specific embodiment of an enterprise environment.

FIG. 5 is a set of flow diagrams for communications where a mobile service provider network is able to move calls to an IP domain in accordance with an embodiment of the inventive arrangements disclosed herein.

### DETAILED DESCRIPTION

The present solution achieves integration between mobile telephony infrastructure assets and an IP based enterprise infrastructure through use of standards based interfaces that do not require any premise based IP-PBX. In one embodiment, the solution can move service control for specific numbers from a mobile switching center to a higher network element, such as a media gateway controller (MGC). The MGC can then be used to bridge SS7 signaling understood by a class five switch in the MSC to SIP. Thus, a call is moved from a channel access (TDMS, CDMA, GSM) domain to an IP domain, where the IP Media System (IMS) core can provide signaling and routing for a call.

Any voice application can be registered using this approach, which makes the disclosed solution a highly flexible and general purpose one. It should be appreciated that in various embodiments, the integration provided by the disclosed solution can enable notification of incoming calls, call routing, presence, location, call history, and a use of more advanced services (e.g., dynamic, real-time text-to-speech and speech-to-text conversions between typed messages at one communication endpoint and voice communication at another communication endpoint, dynamic language translations, transcription services, call routing based upon a detected user current location, etc.).

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, for instance, via optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

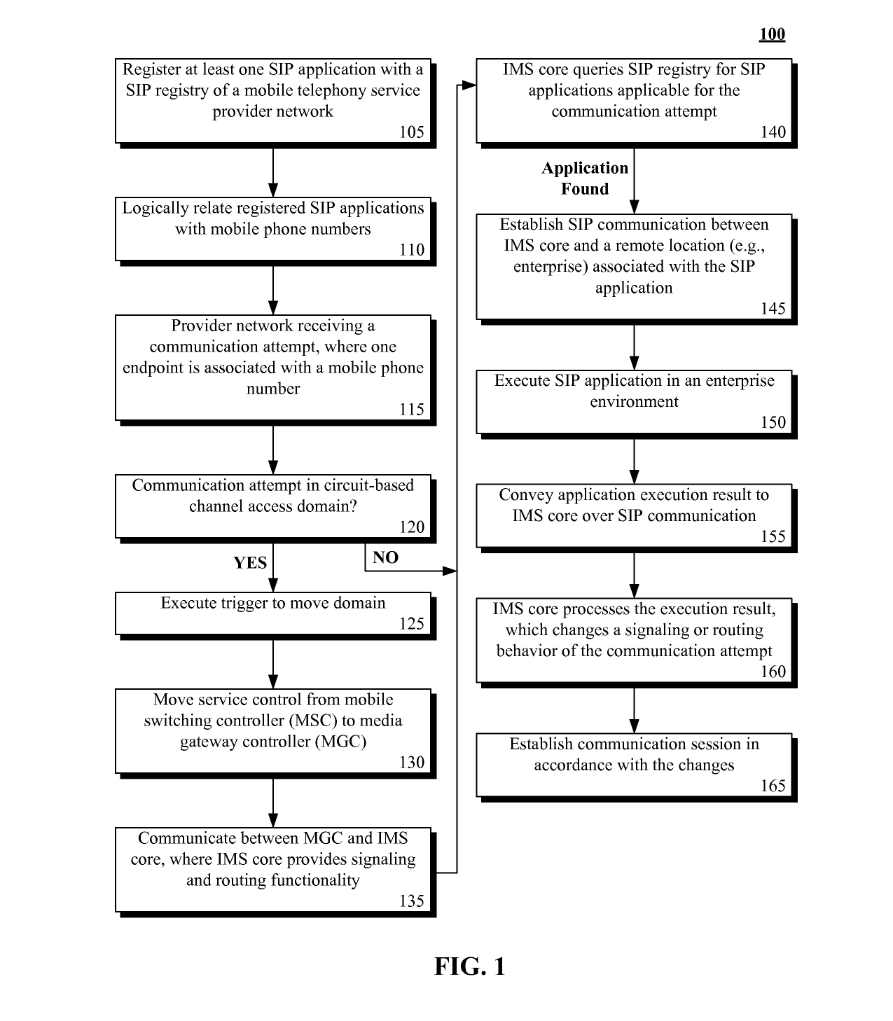

FIG. 1 is a flow chart of a method 100 in which mobile telephony communications are moved from a channel access domain to an IP domain in accordance with an embodiment of the inventive arrangements disclosed herein. The method 100 is a standards based solution, which can be implemented within a mobile telephony service provider's network (referred to hereafter as provider network) without requiring an enterprise IP-PBX to host mobile users. More specifically, service control for calls can be moved from a mobile switching controller (MSC) component to a media gateway controller (MGC) component of the provider network, wherein the MGC component communicates with the IP Multimedia system (IMS) core. The IMS core can then provide signaling and routing functionality for the call.

Passing call control to the IMS core can allow the provider network to identify an application in the SIP registry associated with a particular endpoint (e.g., phone number). That is, any voice application (SIP based) can be registered in this manner and can therefore be automatically executed when previously designated circumstances are satisfied. In one embodiment, the voice application can be a premise based SAMETIME UNIFIED TELEPHONY server from IBM. In other embodiments, the voice application can be another unified telephony solution, a cloud based solution (e.g., GOOGLE's GRAND CENTRAL), or a sophisticated call center application.

As illustrated, method 100 can begin in step 105, where at least one SIP application can be registered with a SIP registry of a mobile telephony service provider network. In one embodiment, the provider network can be Wireless Intelligent Network (WIN) compliant network. Registered SIP applications can be logically related (e.g., via database associations) with a set of phone numbers, as shown by step 110. These phone numbers can include mobile phone numbers handled by the provider network.

The provider network can receive a communication attempt in step 115. One endpoint of the communication attempt can correspond to a phone number in the SIP registry. In step 120, a determination can be made to ascertain whether the domain of the communication needs to be changed. That is, the communication can be initially for the IP domain, in which case no conversion is necessary, as shown by the method selectively skipping from step 120 to step 140.

When the communication is in the channel access domain or otherwise needs converted, a previously established trigger, such as a WIN trigger, can execute, as shown by step 125. In step 130, responsive to the trigger execution, service control can be moved from a mobile switching controller (MSC) to a media gateway controller (MGC). In step 135, communications can occur between the MGC and the IMS core, where the IMS core provides signaling and routing functionality for the communication attempt.

In step 140, the IMS core can query a SIP registry for SIP applications applicable to the communication attempt. When an application is found, a SIP communication can be established between the IMS core and a remote location (e.g., an enterprise) associated with the SIP application, as shown by step 145. In step 150, the SIP application can execute in the application environment. Results from this execution can be conveyed to the IMS core over the SIP communication, as shown by step 155.

In step 160, the IMS core can process the execution result, which can change signaling and/or routing behavior of the communication attempt. In step 165, a communication session can be established in accordance with the changes submitted to the IMS core.

It should be appreciated, that integrating a users mobile phone via the WIN network can add a myriad of functionality, which is not typically available to mobile telephony subscribers for 2G communications (e.g., channel access based calls). By moving call control to the IP domain as described, numerous functional enhancements can be realized. For example, subscribers can be notified of incoming calls and call details when engaged in a voice call, calls directed to mobile phones can be routed, presence features can be enabled, and advanced services (e.g., Web services) can be enabled. An example of an advanced service can include adding speech processing (e.g., text-to-speech, speech-to-text, speaker identification and verification (SIV), etc.) capabilities to a mobile telephony communication.

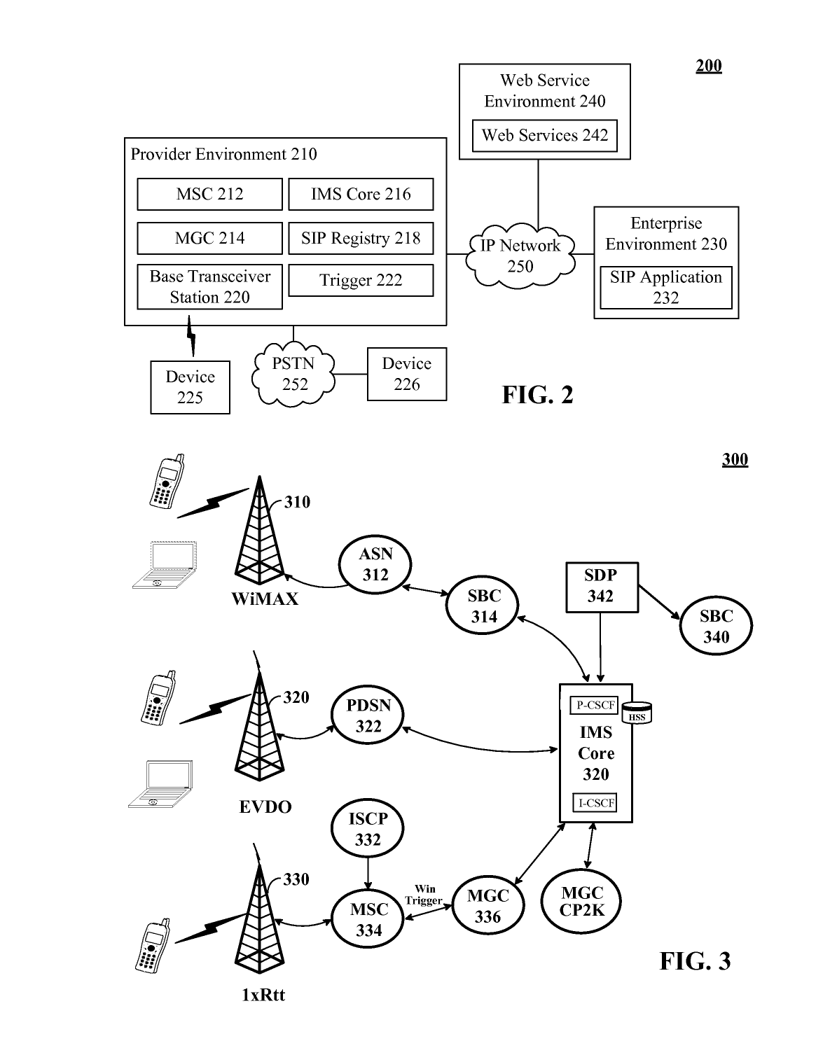

FIG. 2 is a schematic diagram of a communications system 200 that facilitates communications between a provider environment 210 and an enterprise environment 230 by moving communications from a channel access domain to an IP domain in accordance with an embodiment of the inventive arrangements disclosed herein.

As shown, the provider environment 210 can be connected to a Web service environment 240 and an enterprise environment 230 through an IP network 250. Communications handled by the IMS core 216 can make use of zero or more Web services 242 executing in environment 240 and zero or more SIP applications 232 executing in the enterprise environment 230. A SIP registry 218 can associate device 226 identifiers with the applications 232 and services 242.

The provider environment 210 can be a mobile telephony service provider's network supporting 2G, 2.5G, 3G, 4G (Beyond 3G), etc. wireless communications. The provider environment 210 can be communicatively linked to the public switched telephone network (PSTN) 252, which permits communications with devices 226 linked to the PSTN 252. Environment 210 can be capable of channel accessed based wireless communications involving one or more base transceiver station 220 wirelessly linked to a mobile station (e.g., device 225). In one contemplated embodiment, the provider environment 210 can be a Wireless Intelligent Network (WIN) compliant one or can be compliant to another such standard.

A channel accessed wireless communication is one that permits several mobile stations connected to the same multi-point EM spectrum to transmit over it and to share its capacity. Channel access wireless communication techniques can utilize numerous schemes including those based on time division multiple access (TDMA) techniques, code division multiple access (CDMA) techniques, frequency division multiple accessed (FDMA) techniques, and/or space division multiple access (SDMA). Hybrid communication schemes (e.g., Global System for Mobile communications (GSM), those based upon the IEEE 802.XX family of protocols— including WLAN and WIMAX, etc.) can be supported by the provider environment 210. Environment 210 can further support circuit based voice communications (e.g., TDMA, GSM, etc.) and packet based ones (e.g., Evolution-Data Optimized (EVDO), Voice over Internet Protocol (VOIP), etc.).

As shown, provider environment 210 can include an MSC 212 component, a MGC component 214, an IMS core component 216, a SIP registry 218, and one or more base transceiver station 220. Additional components (not shown) can be included in the environment 210, yet have been excluded in FIG. 2 for simplicity of expression of salient characteristics of this disclosure.

The MSC 212 component can be a primary service delivery node for 2G mobile calls. The MSC 212 can be typically responsible for handling voice calls and SMS, as well as other services, such as conference calls, FAX, and circuit switched data. The MSC 212 can set up and release the end-to-end connection, can handle mobility and hand-over requirements during the call, and can take care of charging and real time pre-paid account monitoring.

Trigger 222 can be a programmatic trigger that automatically moves service control from the MSC 212 to the MGC 214. For example in one embodiment, trigger 222 can be a WIN trigger conforming to the WIN call model. The trigger 222 can be a decision point in a call. Specifically, trigger 222 can be designed to move calls from a wireless channel access (2G) domain to an IP domain. This occurs without hosting calls on a premise based IP-PBX.

The MGC component 214 can function as a translation unit between disparate telecommunication networks, such as PSTN, SS7, TDMA, GSM, CDMA, and the like. The MGC 214 can convert (e.g., transcode) between different transmission and coding techniques.

The IMS core component 216 can be a core component for delivering Internet protocol (IP) multimedia services. The IMS core 216 together with the MGC can provide signaling and routing functionality. The IMS core 216 can include a number of Call Session Control Function (CSCF) proxies, such as a Proxy-CSCF (P-CSCF), a Serving-CSCF (S-CSCF), and an Interrogating-CSCF (I-CSCF).

The SIP registry 218 can be implemented as a master user database. Thus, the SIP registry can be implemented within a home subscriber server (HSS), a user profile server function (UPSF), a Home Location Register (HLR), or even a Visitor Local Register (VLR). The SIP registry 218, when associated with a HLR or VLR, can be used in conjunction with an authentication center (AUC).

One specific embodiment 300 of a provider environment 210 is shown in FIG. 3. More specifically, embodiment 300 represents a mobile telephony service provider network modeled after SPRINT's architecture. It should be understood that embodiment 300 is not to be construed as limiting the disclosure's scope and that the disclosure functions under architectures.

In embodiment 300, an IMS core 320 can deliver IP media services, which include voice services which have been moved from the MSC 334 to the MGC 336. A session border controller (SBC) 314, 340 can exert control over media streams and can be involved in setting up, conducting, and tearing down calls. A service delivery platform (SDP) 342 can be a set of components that provide a service delivery architecture (e.g., service creation, session control, protocols) for a type of service. The SDP 342 can be used to enable externally provided Web services (the Web services 242 of system 200 for example).

Embodiment 300 supports multiple different communication protocols including WIMAX, EVDO, and TDMA, each of which can be associated with its own set of base transceiver stations 310, 320, 330 and base station controllers. WIMAX communications can be conducted through an access service network (ASN) component 312. EVDO communications can be conducted through a public data switched network (PDSN) component 322. Channel based, circuit switched (e.g., TDMA) communications can include an integrated services control point (ISCP) communicatively linked to the MSC 334.

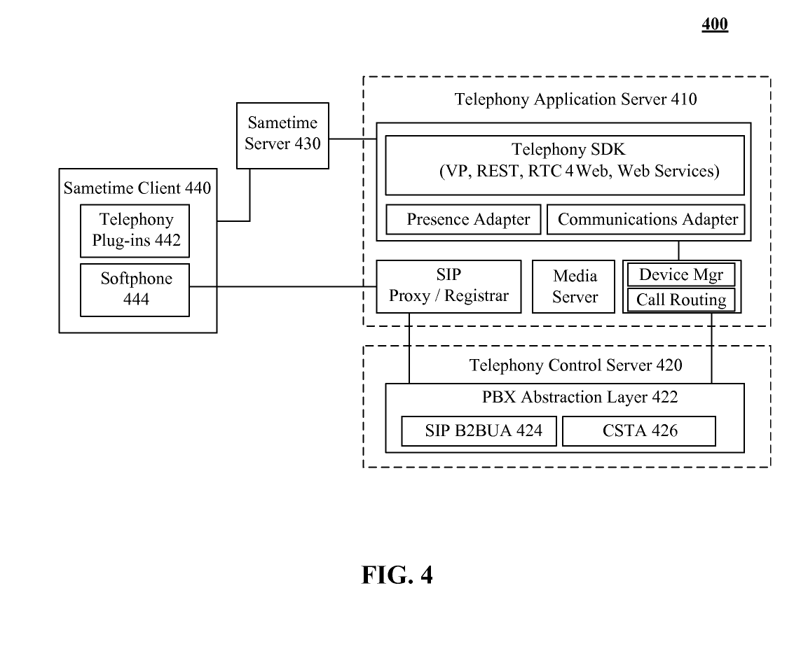

One specific embodiment 400 of an enterprise environment 230 is shown in FIG. 4. More specifically, embodiment 400 represents a unified telephony architecture based upon the SAMETIME UNIFIED TELEPHONY architecture of IBM. It should be understood that embodiment 400 is not to be construed as limiting the disclosure's scope.

In embodiment 400, a telephony control server 420 can interface over an IP network (e.g., network 250) with a provider network (such as with IMS core 216). Interactions can be conducted through a PBX abstraction layer 422, which includes a SIP Back-To-Back User Agent (SIP B2BUA) 424 and a CSTA user agent 426.

The telephony control server 420 can interface with telephony application server 410, which can interface with both the SAMETIME server 430 and a softphone 444 of a SAMETIME client 440. The SAMETIME client 440 can also include telephony plug-ins 442.

In one implementation, the inventive arrangements disclosed here permit a mobile telephony subscriber to have a unified experience in that calls directed to/from a mobile phone number are able to be handled in a same manner as land-based calls. Historically, this required a premise based PBX, a costly wireless integration service (e.g., AVAYA WIRELESS INTEGRATION), or proprietary non-standards based solution programming that was generally highly limited. Combining embodiment 300 and 400, a wireless service provider network is directly integrated into an enterprise environment, with call control functionality occurring within the mobile telephony network. Thus, a SPRINT network (embodiment 300) can be integrated into a unified communication (U2) enterprise environment (embodiment 400) to produce a U3 environment, which is an integration of UC2 and wireless telephony.

Capabilities realizable by the present disclosure can be described utilizing a set of use cases. In one use case, a telephony call can be initiated directed to John, who receives UC3 services. The call is directed to John's mobile telephony number. The call attempt is initially directed to the wireless provider's network. Before ringing any phone, the mobile provider via IMS services informs the UC2 application executing within an enterprise of the call attempt (including caller ID). The UC2 application can look up John's schedule, calendar, and presence information, which along with the caller ID determines where to route the incoming call. Because John is logged onto SAMETIME at his home office and is available, the UC2 can inform the service provider that the call should be redirected to John's home phone number. In this use case, it should be noted that the call attempt was redirected, not answered and forwarded. Additionally, no enterprise telephony resource is required in the above use case.

In another use case, John can be participating in a conference call using his mobile phone. A call can be initiated from Jane, which is directed to John's mobile telephony number. Jane's call attempt can be conveyed to the mobile provider's network, where the IMS services communicate with the UC2 application executing in the enterprise environment. The UC2 application can check John's schedule, calendar, presence, and caller ID. Because John is currently in a meeting, the call can be routed to Voice Mail by default. John's mobile phone can include a UC3 application that shows incoming calls and offers a number of options relating to them. John, who may be almost done with the conference call, can elect to type a message (using text messaging capabilities of his mobile phone) for Jane, such as “In a meeting be done in 5 min. I'll call you.” The message can be conveyed to the provider network, where speech-to-text conversion occurs (through a Web service, for example) and the message is played to Jane over a voice phone connection. When John finishes his conference call, the U3C application on the mobile phone can initiate the call with Jane. While John and Jane are talking, a question can arise that Sue knows the answer to. John can start a SAMETIME chat with Sue during which he determines that Sue should join the call. From the SAMETIME chat window, John can select to add Sue to the call.

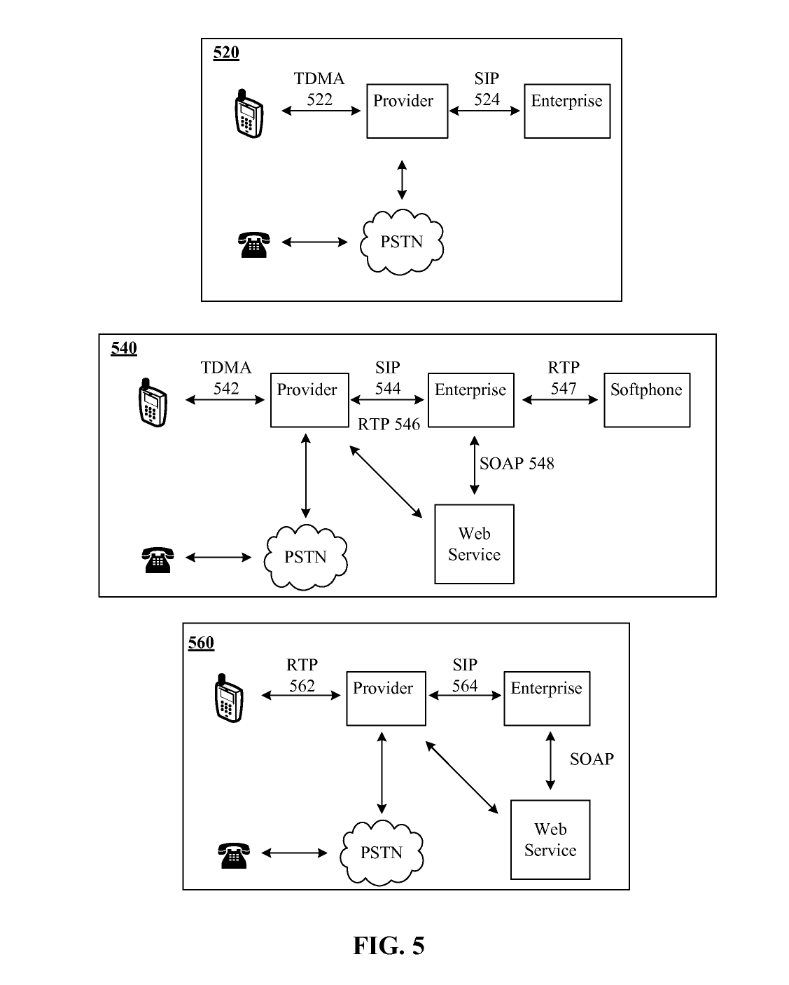

FIG. 5 is a set of flow diagrams 520, 540, 560 for communications where a mobile service provider network is able to move calls to an IP domain in accordance with an embodiment of the inventive arrangements disclosed herein. These diagrams 520, 540, 560 show that the inventive arrangements of the disclosure are flexible and can handle different communication protocols. That is, once call control is moved to the IP domain, all communication protocols supported by the IMS core are able to be used.

Diagram 520 is a network/flow diagram for a call coming in on a TDMA 522 circuit, which is routed to a home office phone. When the TDMA call 522 attempt is received by the provider, it is routed through the MSC to a MGC, where it is converted to the IP domain. A SIP channel 524 is established between the provider and an enterprise. The enterprise can communicate over the SIP channel 524, conveying results that potentially alter routing and/or signaling of the call. This call is established between the mobile phone and the phone office phone that is linked to the Public Switched Telephone Network (PSTN).

Diagram 540 uses Web services and SIPS rather than a virtual private network (VPN) for presences and SIP signal flowing. In diagram 540, the TDMA 542 call attempt is received by the provider, where it is routed through the MSC, to the MGC, to the IMS core, to a SDP. The SDP can communicate with one or more Web services. Each executing Web service can communicate with the enterprise over a SOAP connection 548. The SDP can communicate through a SBC with enterprise over a SIP connection 544. The call modified by the Web service and/or enterprise application results can be established between the mobile device and a home phone network (connected via PSTN).

In an alternative embodiment, still based on diagram 540, the mobile phone can initiate a communication having a softphone as an endpoint. This can require RTP 546 communications be established between the provider and the enterprise and between (see RTP 547) the enterprise and a softphone.

Diagram 560 shows that the solution works seamlessly across multiple generations of mobile communications and wire-line endpoints. As shown in diagram 560, a 4G device (e.g., WIMAX device) can communicate with the provider using RTP 562. The provider can route the call through a ASN and SBC to the MGC, which can communicate with the IMS core of the provider. The provider can then initiate a SIP 564 communication with the enterprise and can optionally execute a Web service (through a SDP, for example) for the WIMAX call.

The flowchart and block diagrams in the FIGS. 1-5 illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for handling mobile communications comprising:
identifying a telecommunication call attempt at a telephony service provider network, wherein at least one endpoint of said telecommunication call attempt is associated with a phone number of a mobile communication device, wherein said telephony service provider network provides mobile telephony service for said mobile communication device;
utilizing an IP Multimedia system (IMS) core component of the telephony service provider network to provide signaling and routing functionality for the telecommunication call attempt;
the IMS core identifying at least one application registered in a SIP registry that is associated with a phone number of the mobile communication device;
establishing a SIP communication between the IMS core and the identified application, which a SIP based message from the IMS core causes the identified application to execute, wherein said identified application executes in a computing device remote from the telephony service provider network; and
said IMS core receiving at least one SIP message over the established SIP communication responsive to an execution of the identified application, said SIP message resulting in a change of at least one of the signaling and routing performed by the IMS core for the telecommunication call attempt, wherein in absence of said change resulting from the SIP message, the telecommunication call attempt causes the telephony service provider network to attempt to establish a wireless voice communication with the mobile communication device using a channel accessed based communication connection.

2. The method of claim 1, further comprising:
moving service control within the telephony service provider network for the telecommunication call attempt from a circuit switched, channel access domain to an IP domain by moving control from a mobile switching controller component to a media gateway controller component of the telephony service provider network, wherein the media gateway controller component communicates with the IMS core.

3. The method of claim 2, further comprising:
executing a programmatic trigger responsive to identifying the telecommunication call attempt, wherein execution of said programmatic trigger moves the service control from the mobile switching controller component to the media gateway controller component.

4. The method of claim 1, wherein said identified application executes within an enterprise environment comprising said computing device that executes said identified application.

5. The method of claim 4, wherein said established SIP communication occurs via a dedicated virtual private network (VPN) established directly between said telephony service provider network and said enterprise environment.

6. The method of claim 4, wherein said telephony service provider network comprises a service delivery platform (SDP) component connected to the IMS core, wherein the SDP is a communication intermediary between the IMS core and a plurality of Web services that execute remotely from the telephony service provider network, wherein said Web services are invoked from the telephony service provider network and result in a SOAP connection being established between at least one of the Web services and the enterprise environment.

7. The method of claim 4, wherein another communication endpoint involved in the said telecommunication attempt communicates with the telephony service provider network utilizing a real time protocol (RTP) based communication linkage, wherein the mobile communication device communicates with the telephony service provider network utilizing said channel accessed based communication connection.

8. The method of claim 4, wherein said enterprise environment is configured to provide enterprise users with a plurality of unified communication and collaboration services, said unified communication and collaboration services comprising at least three of instant messaging, calendaring, presence services, bidirectional real-time or near-real time voice communications via at least one IP based audio stream, Web conferencing, file transfer services, and GUI screen capture and sharing services, wherein execution of the identified application permits the unified communication and collaboration services of the enterprise environment to be applied to the telecommunication call attempt.

9. The method of claim 8, wherein said method permits subscribers utilizing mobile telecommunication devices to have a common communication experience regarding the unified communication collaboration services as the subscribers would experience from a wire line phone or a VOIP phone, and wherein no IP-PBX is used to host said subscribers when utilizing the mobile telecommunication devices.

10. The method of claim 1, wherein said SIP registry is contained within at least one of a Home Subscriber Server (HSS) and a Home Location Register (HLR).

11. A computer program product for handling mobile communications comprising: a computer usable medium having computer usable program code embodied therewith, the computer usable program code comprising:
computer usable program code configured to identify a telecommunication call attempt at a telephony service provider network, wherein at least one endpoint of said telecommunication call attempt is associated with a phone number of a mobile communication device, wherein said telephony service provider network provides mobile telephony service for said mobile communication device;
computer usable program code configured to utilize an IP Multimedia system (IMS) core component of the telephony service provider network to provide signaling and routing functionality for the telecommunication call attempt;
computer usable program code configured to identify at the IMS core at least one application registered in a SIP registry that is associated with a phone number of the mobile communication device;
computer usable program code configured to establish a SIP communication between the IMS core and the identified application, which a SIP based message from the IMS core causes the identified application to execute, wherein said identified application executes in a computing device remote from the telephony service provider network; and
computer usable program code configured to receive at the IMS core at least one SIP message over the established SIP communication responsive to an execution of the identified application, said SIP message resulting in a change of at least one of the signaling and routing performed by the IMS core for the telecommunication call attempt, wherein in absence of said change resulting from the SIP message, the telecommunication call attempt causes the telephony service provider network to attempt to establish a wireless voice communication with the mobile communication device using a channel accessed based communication connection.

12. A method for providing enterprise services to mobile telephony device subscribers comprising:
registering a plurality applications with a SIP registry of a telephony service provider network, wherein said telephony service provider network provides mobile telephony service for a plurality of mobile telephony devices, wherein the registered applications execute in a computing system external to the telephony service provider network;
moving service control for mobile telephony communications of subscribers from a channel access domain to an IP domain by moving control from a mobile switching controller component to a media gateway controller component of the telephony service provider network, wherein the media gateway controller component communicates with an IMS core component of the telephony service provider network;
the IMS core selectively identifying at least one application registered in the SIP registry that is to be executed for a telephony communication involving a subscriber of the mobile telephony service identified by a mobile phone number;
establishing a SIP based communication connection between the IMS core and the identified application;
conveying data between the IMS core and the identified application via the SIP based communication connection; and
the IMS core changing at least one of signaling and routing behavior of the telephony communication based on results from executing the identified application that is received over the SIP based communication.

13. The method of claim 12, wherein during the telephony communication a mobile communication device of one of the subscribers communicates with the telephony service provider network using a channel accessed based communication connection.

14. The method of claim 12, wherein said identified application executes within an enterprise environment, wherein said enterprise environment is configured to provide enterprise users with a plurality of unified communication and collaboration services, said unified communication and collaboration services comprising at least three of instant messaging, calendaring, presence services, bidirectional real-time or near-real time voice communications via at least one IP based audio stream, Web conferencing, file transfer services, and GUI screen capture and sharing services, wherein execution of the identified application permits the unified communication and collaboration services of the enterprise environment to be applied to subscribers of mobile telephony services provided by the telephony service provider network.

15. The method of claim 14, wherein said method permits said subscribers utilizing mobile telecommunication devices to have a common communication experience regarding the unified communication collaboration services as the subscribers would experience from a wire line phone or a VOIP phone, and wherein no IP-PBX is used to host said subscribers when utilizing the mobile telecommunication devices, and wherein said moving of the service control utilizes standards based interfaces.

16. The method of claim 12, wherein said SIP registry is contained within at least one of a Home Subscriber Server (HSS) and a Home Location Register (HLR).

17. A mobile telephony system comprising:
a mobile switching controller (MSC);
a media gateway controller (MGC);
an IP Media System (IMS) core; and
a programmatic trigger configure to move service control for 2G wireless voice communications from a circuit switched, channel access domain to an IP domain by moving control from the MSC to the MGC.

18. The system of claim 17, further comprising:
a SIP registry configured to register a plurality of SIP applications executing in an enterprise environment remote from the mobile telephony system, wherein the registration of SIP applications in the SIP registry associates the SIP applications with mobile telephony numbers, wherein calls having at least one mobile telephony number as an endpoint are able to selectively trigger execution of SIP applications associated with that mobile telephony number based upon entries contained in the SIP registry, wherein said SIP registry is contained within at least one of a Home Subscriber Server (HSS) and a Home Location Register (HLR).

19. The system of claim 17, further comprising:
at least one base transceiver station configured to wirelessly communicate via circuit based, channel access wireless links with mobile stations utilizing at last one of 2G, 2.5G, 3G wireless protocols.

20. The system of claim 18, further comprising
a service delivery platform (SDP) component connected to the IMS core, wherein the SDP is a communication intermediary between the IMS core and a plurality of Web services that execute remotely from the mobile telephony system, wherein said Web services are invoked from the mobile telephony system and result in a SOAP connection being established between at least one of the Web services and the enterprise environment.
